(19) United States
(12) Patent Application Publication
(10) Pub. No.: US 2004/0254775 A1
(43) Pub. Date: Dec. 16, 2004

(54) Method and apparatus to characterize an electronic device

(76) Inventor: Arpad Muranyi, Folsom, CA (US)

Correspondence Address: CLIVE MENEZES & ASSOCIATES, P.C., PMB 193, 6705 HWY 290 WEST, SUITE 502, AUSTIN, TX, 78735-8407, US

(21) Appl. No.: 10/461,217

(22) Filed: Jun. 13, 2003

(51) Int. Cl. G06F 17/50

(52) U.S. Cl. 703/16

(57) ABSTRACT

A method and apparatus to characterize an electronic device comprising generating a Simulation Program with Integrated Circuit Emphasis (SPICE) model of the electronic device, the electronic device having a load. Running a time domain simulation using a waveform as input into the SPICE model of the electronic device and running the time domain simulation for a period of time. Generating a set of operating points for the electronic device at a selected instance during the period of time. And running a frequency domain simulation of the SPICE model using the generated set of operating points said frequency domain simulation using an alternating current (AC) source. The method further comprises generating at least one of a plot, and a behavioral model using the method described above. The above method may be repeated by varying one or more simulation parameters.

### BACKGROUND

1. Field of the Invention

The present invention is related to the field of circuit design. In particular, the present invention is related to a method and apparatus to characterize an electronic device.

1. Description of the Related Art

Input/Output (I/O) Buffer Information Specification (IBIS) is a standard that describes the analog behavior of buffers of digital devices using the American Standard Code for Information Interchange (ASCII) text formatted data. Using IBIS one can develop a behavioral model for buffers so that “what if” analysis can be easily performed. As illustrated in FIG. 1, in an IBIS model 100 a buffer comprises one or more impedances 105-115 connected between the power supply pin (Vcc) of the buffer and the I/O pin of the buffer, between the Vcc pin of the buffer and the ground (GND) pin, and between the I/O pin and the ground pin (GND). As illustrated in FIG. 1 the IBIS model impedances are complex quantities that have a real part and an imaginary part that describe the behavior of the buffer. The threshold and 3-state control box determines the buffer state depending on the signals input at the input (IN) and enable (EN) pins. The Ramp up and Ramp down boxes inform the simulation tool how to transition from a low state to a high state and vice versa. Pull-up and Pull-down I-V are the IV (current-voltage) curves of the pull-up and pull-down transistors in the buffer. The power and ground clamp I-V box coupled to the Pull-up I-V box and the Pull-down I-V boxes respectively are the IV curve of the clamping circuits (e.g., diodes) of the buffer. Capacitances C_comp_pu and C_comp_pd represent the total capacitances of the die comprising the buffer. The IBIS model impedances are time variant, and frequency and voltage dependent and model the buffer for signals input at the IN pin as well as for 3-state conditions of the buffer.

The IBIS model described above is based on the steady state IV curve analysis of the buffer and therefore, does not have adequate transient, or any frequency dependent information. For the IBIS model, the transient behavior of the I/O buffers are reverse engineered, using some technical assumptions, by IBIS simulators using the [Ramp] or [Rising Waveform] and/or [Falling Waveform] ([*** Waveform]) data contained in the IBIS files for the buffer. The meaning of [Ramp] and [***Waveform] data as well as the technical assumptions used to model the transient behavior of the buffer is well known to one having ordinary skill in the art. The IBIS model has the advantage of fast simulation speed, and helps to protect the actual circuit design of the buffer by providing the behavioral model of the buffer to designers that use the buffers in their designs. However, the techniques used to reverse engineer the transient behavior from the [Ramp] and/or [*** Waveform] data makes the IBIS models less accurate. Furthermore, not having frequency dependent information for the buffers also makes the IBIS models less accurate.

### BRIEF SUMMARY OF THE DRAWINGS

Example embodiments of the present invention are illustrated in the accompanying drawings. The accompanying drawings, however, do not limit the scope of the present invention. Similar references in the drawings indicate similar elements.

FIG. 1 illustrates a conventional IBIS buffer model.

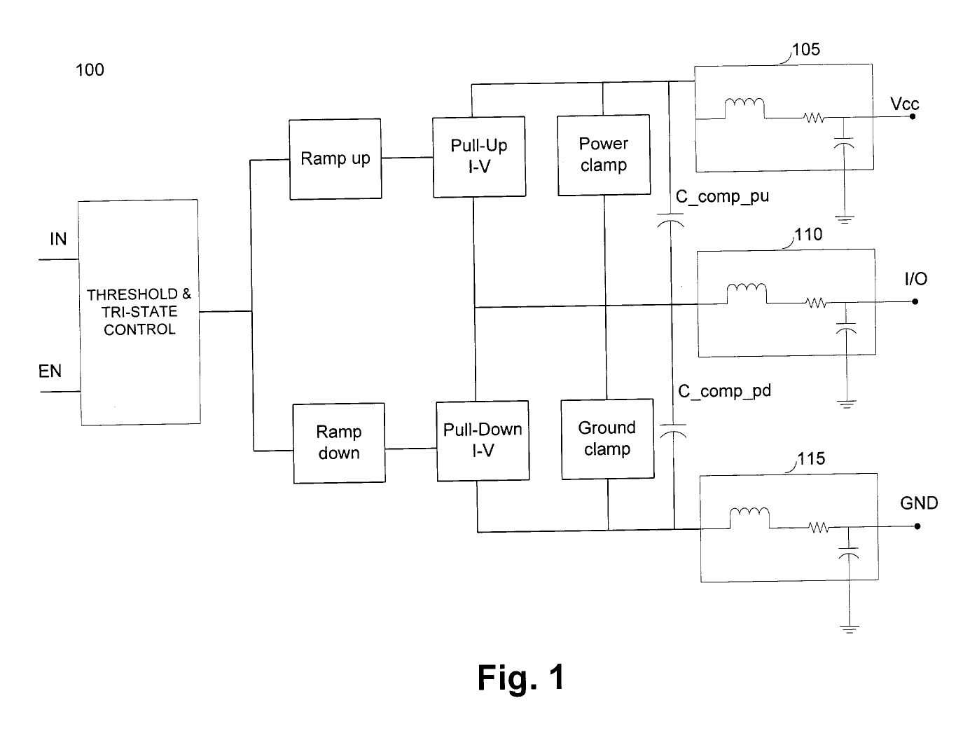

FIG. 2 illustrates a flow diagram for characterizing an electronic device according to one embodiment of the invention.

FIG. 3 illustrates a multidimensional characterization of an electronic device according to one embodiment of the invention.

FIG. 4 illustrates a computer system for characterizing an electronic device according to one embodiment of the invention.

### DETAILED DESCRIPTION

Described is a method and apparatus to characterize an electronic device comprising generating a Simulation Program with Integrated Circuit Emphasis (SPICE) model of the electronic device, the electronic device having a load. Running a time domain simulation using a waveform as input into the SPICE model of the electronic device and running the time domain simulation for a period of time. Generating a set of operating points for the electronic device at a selected instance during the period of time. And running a frequency domain simulation of the SPICE model using the generated set of operating points said frequency domain simulation using an alternating current (AC) source. In one embodiment of the invention, the frequency domain simulation of the SPICE model is run one or more times, using the generated set of operating points with a direct current (DC) offset voltage superimposed on the AC source. The method further comprises generating at least one of a plot, and a behavioral model using the method described above.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to effect such feature, structure, or characteristic in connection with other embodiments whether or not explicitly described. Parts of the description are presented using terminology commonly employed by those of ordinary skill in the art to convey the substance of their work to others of ordinary skill in the art.

In the following description and claims, the terms “coupled” and “connected”, along with derivatives such as “communicatively coupled” may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct physical contact with each other, but still co-operate or interact with each other.

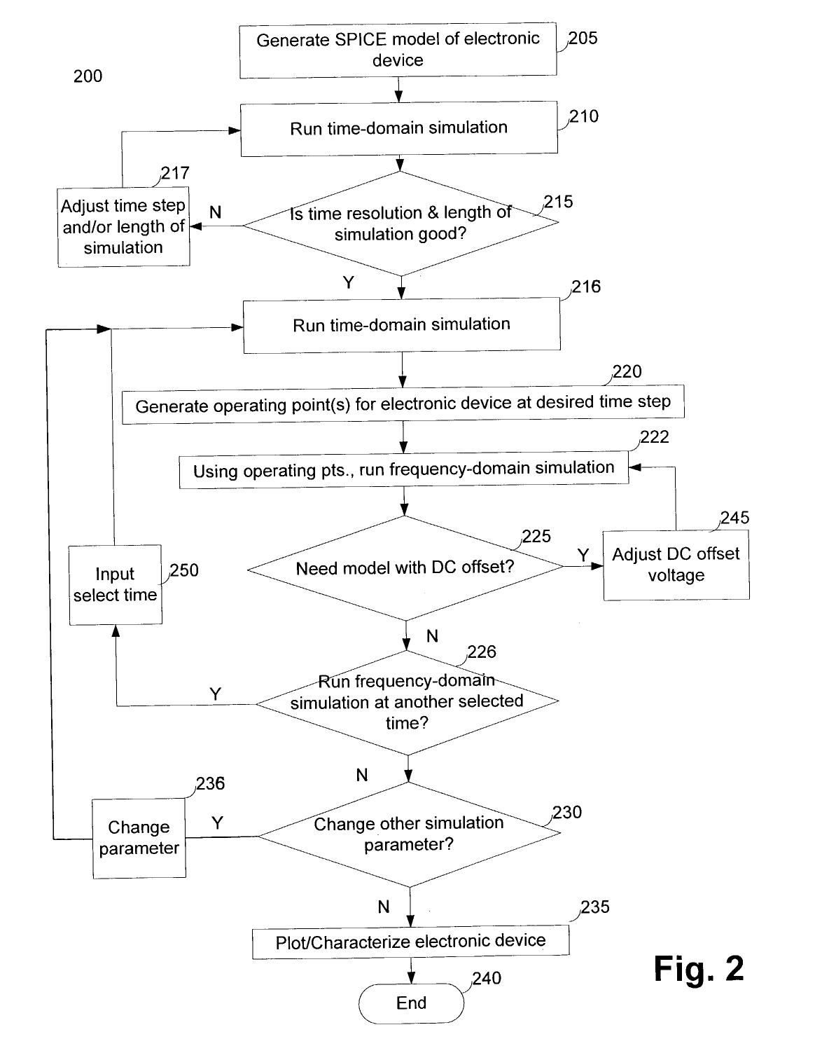

FIG. 2 illustrates a flow diagram for characterizing an electronic device according to one embodiment of the invention. As illustrated in FIG. 2, flow diagram 200 comprises, at 205, generating a Simulation Program with Integrated Circuit Emphasis (SPICE) model of the electronic device that needs to be characterized. One having ordinary skill in the art will appreciate that the electronic device may include any integrated circuit devices such as op-amps, inverters, buffers etc. and discreet devices such as bipolar junction transistors, field effect transistors, etc. At 210, a time-domain simulation is run using e.g., SPICE, PSPICE, HSPICE etc., well known by one having ordinary skill in the art. In one embodiment of the invention, the time-domain simulation is run using a waveform that has a high to low transition. In another embodiment of the invention the time-domain simulation may be run using a waveform with a low to high transition. In one embodiment of the invention, the time-domain simulation is run with a 3-state to high, a 3-state to low input waveform, a high to 3-state, or a low to 3-state input waveform. In one embodiment of the invention the SPICE model of the electronic device has an impedance load at its output, the impedance load may have any value from 0 ohms (short circuit) to open circuit. In one embodiment of the invention, either during or after running the time-domain simulation, the data including the operating points generated for one or more selected nodes comprising the circuit of the electronic device is saved. At 215, a determination is made whether the time resolution and the time duration during which the simulation is run are acceptable. If the time resolution and/or the time duration, during which the simulation is run is not acceptable, at 217 an adjustment is made to the time resolution (i.e., a time step) and/or the time duration. If at 215 the time resolution and the time duration during which the simulation is run is acceptable, at 216 the time-domain simulation is run for at least a selected time during the time duration using one of the input waveforms described above. At 220, one or more operating points (i.e., a set of operating points) is generated by the simulation program for selected nodes comprising the circuit of the electronic device at the selected time. In one embodiment of the invention the generated set of operating points is saved e.g., to a persistent data storage device. In one embodiment of the invention, the generation of the set of operating points comprises calculating and saving the voltages and currents of the electronic device at selected nodes and branches in the circuit comprising the electronic device.

At 222, a frequency-domain simulation using the SPICE model of the electronic device is run using the set of operating points generated during the time-domain analysis. In one embodiment of the invention, when running the frequency domain simulation, the impedance load at the output of the SPICE model of the electronic device is replaced with an alternating current (AC) frequency generator having a selected AC voltage. In one embodiment of the invention, the output current of the electronic device is measured for the various simulated AC voltage frequencies generated by the AC frequency generator. In one embodiment of the invention the output current is the current through the frequency generator. Thus at 222, a frequency response of the SPICE model of the electronic device is generated using the AC frequency generator to sweep a selected range of frequencies at the output of the electronic device.

At 225, a determination is made whether the electronic device needs to be characterized with a DC offset voltage superimposed on the AC frequency generator. If the effects of the offset voltage on the electronic device is to be characterized, at 245 the DC offset voltage is adjusted to a selected DC voltage level and the frequency-domain simulation is re-run at 222. Thus, for example, if the AC frequency generator has a DC offset voltage superimposed on the generated AC frequencies, and the effect of the DC offset voltage is also to be characterized, the DC offset voltage is adjusted to a selected value. For each selected DC offset voltage, the frequency-domain simulation is re-run for the set of operating points generated during the time-domain analysis.

However, if the effects of the DC offset voltage are not to be modeled, at 226 a determination is made whether the frequency domain simulation is to be run at another selected time during the time duration. If the answer at 226 is affirmative, the selected time is input into the simulation program at 250 and the time-domain and the frequency-domain simulation are repeated using the selected time. For the new selected time a new set of operating points are generated. If at 226 the frequency domain simulation is not to be run at another selected time, at 230 a decision is made whether another simulation parameter needs to be changed. In one embodiment of the invention, changing other simulation parameters include changing parameters, such as temperature, humidity, supply voltage, process variations, etc. If other simulation parameters need to be changed, at 236 the other simulation parameter is changed and the time-domain and frequency-domain simulations are repeated. If at 230 other simulation parameters are not to be changed, at 235, the data obtained from at least the frequency-domain simulation may be plotted and/or the electronic device is characterized. In one embodiment of the invention, the data is plotted and/or is used to characterize the electronic device (i.e., a behavioral model is generated) using e.g., a multi-dimensional chart. In one embodiment of the invention, a multi-dimensional chart may have the impedance of the electronic device calculated and plotted on a vertical axis with respect to time and frequency plotted on the horizontal axes for a given input waveform and/or a given bias voltage. The process ends at 240.

Although, the method described in FIG. 2 uses a simulation program e.g., SPICE to characterize the electronic device, one having ordinary skill in the art will appreciate that the electronic device may also be characterized using appropriate electronic equipment. For example, the time-domain analysis may be performed using a function generator to couple an input waveform into the circuit comprising the electronic device. One or more oscilloscopes and ammeters may be used to record the operating points at various nodes and branches in the circuit comprising the electronic device for the duration of the input waveform. In one embodiment of the invention, from the set of operating points recorded, the voltage and current conditions dictated by a selected set of operating points may be duplicated in the circuit comprising the electronic device e.g., using a power supply and/or other electronic equipment. For this selected set of operating points, an AC frequency generator is operated as described with respect to FIG. 2. Thus, the AC frequency generator may be used to replace the load and to sweep a range of frequencies during the frequency domain analysis. The output current of the electronic device is measured (using an ammeter) for the various AC voltage frequencies generated by the AC frequency generator. In one embodiment of the invention the output current is the current through the frequency generator. Thus, an electronic device may be characterized without using a simulation program as described with respect to FIG. 2.

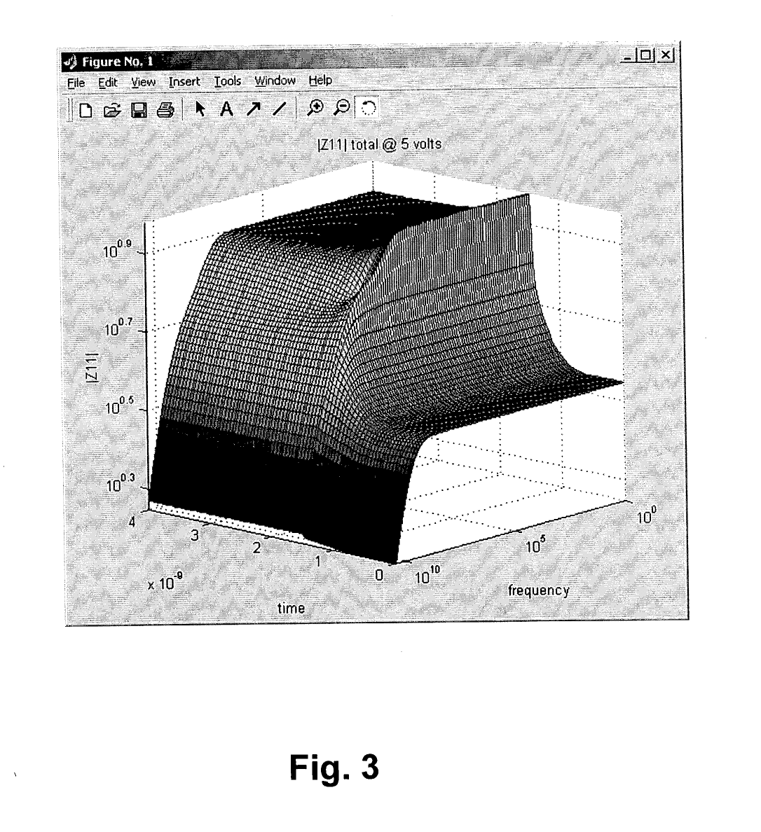

FIG. 3 illustrates a multidimensional characterization of an electronic device according to one embodiment of the invention. In particular, FIG. 3 illustrates the magnitude of the impedance of an I/O buffer in a multidimensional characterization i.e., an impedance, time and frequency characterization during a high to low transition of an input waveform when the output frequency is biased with a 5 volt DC voltage. As illustrated in FIG. 3 the impedance |Z11| of the I/O buffer is plotted on the vertical axis of a three dimensional graph with respect to time and frequency plotted on each horizontal axis of the multi dimensional graph. Although FIG. 3 illustrates the characterization of three parameters of the I/O buffer, other embodiments of the invention may characterize any number of parameters for any electronic device.

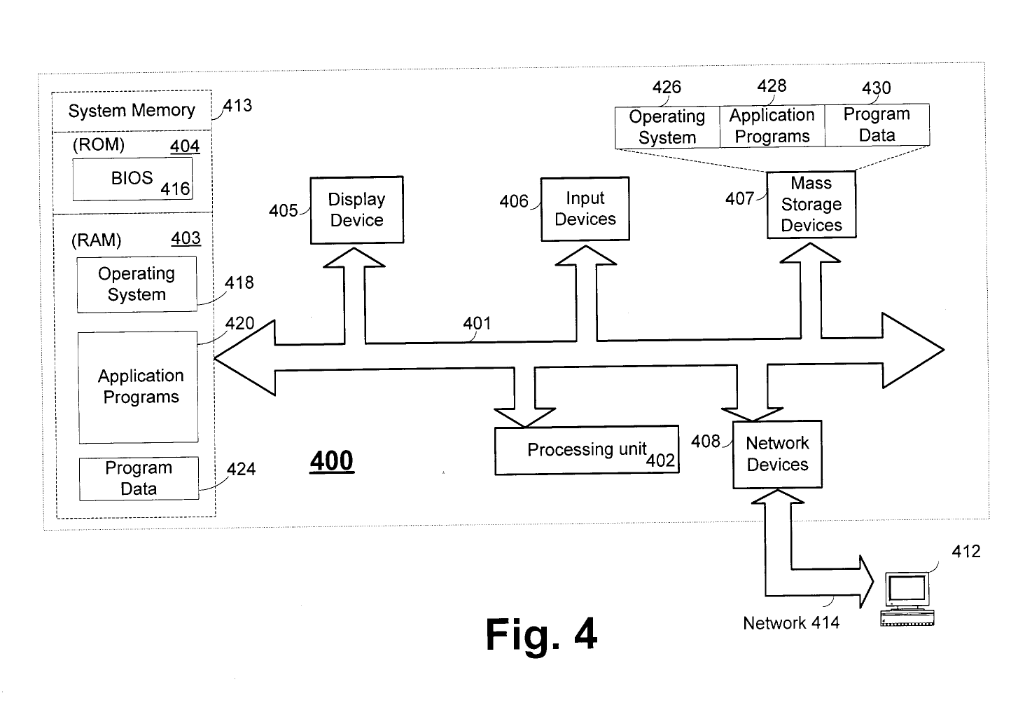

FIG. 4 illustrates a computer system for characterizing an electronic device according to one embodiment of the invention. In general, the computer system 400 may comprise a processing unit 402 communicatively coupled through a bus 401 to system memory 413, mass storage devices 407, Input devices 406, display device 405 and network devices 408.

Bus 401 may be any of several types of bus structures including a memory bus, a peripheral bus, and a local bus using any of a variety of bus architectures. System memory 413 comprises a read only memory (ROM) 404 and random access memory (RAM) 403. ROM 404 comprises basic input output system (BIOS) 416. BIOS 416 contains the basic routines, e.g., start up routines, that facilitate the transfer of information between elements within computer system 400. RAM 403 includes cache memory and comprises operating system 418, application programs 420, and program data 424. Application programs 420 include the program code for implementing the method to characterizing an electronic device as described with respect to FIGS. 2-3 above. Program data 424 may include data generated by application programs 420. Mass storage device 407 represents a persistent data storage device, such as a floppy disk drive, fixed disk drive (e.g., magnetic, optical, magneto-optical, or the like), or streaming tape drive. Mass storage device 407 may store application programs 428, operating system 426 for computer system 400, and program data 430. Application programs 428 and program data 430 stored on mass storage devices 407 may include the application programs 420 and program data 424 stored in RAM 403. One embodiment of the invention may be stored entirely as a software product on mass storage device 407. Embodiments of the invention may be represented as a software product stored on a machine-readable medium (also referred to as a computer-accessible medium, a machine-accessible medium, or a processor-accessible medium). The machine-readable medium may be any type of magnetic, optical, or electrical storage medium including a diskette, CD-ROM, memory device (volatile or non-volatile), or similar storage mechanism. The machine-readable medium may contain various sets of instructions, code sequences, configuration information, or other data. Those of ordinary skill in the art will appreciate that other instructions and operations necessary to implement the described invention may also be stored on the machine-readable medium. One embodiment of the invention may be embedded in a hardware product, for example, in a printed circuit board, in a special purpose processor, or in a specifically programmed logic device communicatively coupled to bus 401. Processing unit 402 may be any of a wide variety of general-purpose processors or microprocessors (such as the Pentium processor family manufactured by Intel® Corporation), a special purpose processor, or a specifically programmed logic device. Processing unit 402 is operable to receive instructions which, when executed by the processing unit cause the processing unit to execute application programs 420.

Display device 405 is coupled to processing unit 402 through bus 401 and provides graphical output for computer system 400. Input devices 406 such as a keyboard or mouse are coupled to bus 401 for communicating information and command selections to processing unit 402. Other input devices may include a microphone, joystick, game pad, scanner, or the like. Also coupled to processing unit 402 through bus 401 is an input/output interface (not shown) which can be used to control and transfer data to electronic devices (printers, other computers, etc.) connected to computer system 400. Computer system 400 includes network devices 408 for connecting computer system 400 to one or more remote devices (e.g., the receiving node) 412 via network 414. Remote device 412 may be another personal computer, a server, a router, a network PC, a wireless device or other common network node and typically includes one or more of the elements described above with respect to computer system 400. Network devices 408, may include a network interface for computer system 400, Ethernet devices, network adapters, phone jacks, modems, and satellite links. It will be apparent to one of ordinary skill in the art that other network devices may also be utilized.

Thus, a method and apparatus for characterizing an electronic device has been disclosed. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method to characterize an electronic device comprising:
generating a Simulation Program with Integrated Circuit Emphasis (SPICE) model of the electronic device, the electronic device having a load;
running a time domain simulation using a waveform as input into the SPICE model of the electronic device and running the time domain simulation for a period of time;
generating a set of operating points for the electronic device at a selected instance during the period of time; and
running a frequency domain simulation of the SPICE model using the generated set of operating points, said frequency domain simulation using an alternating current (AC) source.

2. The method of claim 1 further comprising running the frequency domain simulation of the SPICE model using the generated set of operating points with a direct current (DC) offset voltage superimposed on the AC source.

3. The method of claim 1 further comprising generating at least one of a plot and a behavioral model using at least the frequency domain simulation of the SPICE model at the selected instance during the period of time.

4. The method of claim 2 further comprising generating at least one of a plot and a behavioral model using at least the frequency domain simulation of the SPICE model at the selected instance during the period of time.

5. The method of claim 1 wherein the load comprises an impedance that has at least one of a resistive and a reactive component.

6. The method of claim 1 wherein generating a set of operating points for the electronic device comprises generating a voltage and a corresponding current value for a corresponding set of nodes and branches in the electronic device at the selected instance during the period of time.

7. The method of claim 1 wherein generating a set of operating points for the electronic device at a selected instance during the period of time comprises generating and saving the set of operating points corresponding to the selected instance during the period of time.

8. The method of claim 1 wherein running a time domain simulation using a waveform as input into the SPICE model of the electronic device comprises using a waveform having any one of a high to low transition, a low to high transition, a 3-state to high transition, a 3-state to low transition, a high to 3-state transition, and a low to 3-state transition as input into the SPICE model.

9. A system to characterize an electronic device comprising:
a memory;
a processor; and
a bus coupled to the memory and the processor, the processor to
generate a Simulation Program with Integrated Circuit Emphasis (SPICE) model of the electronic device, the electronic device having a load;
run a time domain simulation using a waveform as input into the SPICE model of the electronic device and running the time domain simulation for a period of time;
generate a set of operating points for the electronic device at a selected instance during the period of time; and
run a frequency domain simulation of the SPICE model using the generated set of operating points, said frequency domain simulation using an alternating current (AC) source.

10. The system of claim 9 further comprising the processor to run the frequency domain simulation of the SPICE model using the generated set of operating points with a direct current (DC) offset voltage superimposed on the AC source.

11. The system of claim 9 further comprising the processor to generate at least one of a plot and a behavioral model using at least the frequency domain simulation of the SPICE model at the selected instance during the period of time.

12. The system of claim 10 further comprising the processor to generate at least one of a plot and a behavioral model using at least the frequency domain simulation of the SPICE model at the selected instance during the period of time.

13. The system of claim 9 wherein the processor to generate a set of operating points for the electronic device comprises the processor to generate a voltage and a corresponding current value for a corresponding set of nodes and branches in the electronic device at the selected instance during the period of time.

14. The system of claim 9 wherein the processor to generate a set of operating points for the electronic device at a selected instance during the period of time comprises the processor to generate and save the set of operating points corresponding to the selected instance during the period of time.

15. The system of claim 9 wherein the processor to run a time domain simulation using a waveform as input into the SPICE model of the electronic device comprises the processor to use a waveform having any one of a high to low transition, a low to high transition, a 3-state to high transition, a 3-state to low transition, a high to 3-state transition, and a low to 3-state transition as input into the SPICE model.

16. An article of manufacture to characterize an electronic device comprising:
a machine-accessible medium including instructions that, when executed by a machine, causes the machine to perform operations comprising
generating a Simulation Program with Integrated Circuit Emphasis (SPICE) model of the electronic device, the electronic device having a load;
running a time domain simulation using a waveform as input into the SPICE model of the electronic device and running the time domain simulation for a period of time;
generating a set of operating points for the electronic device at a selected instance during the period of time; and
running a frequency domain simulation of the SPICE model using the generated set of operating points, said frequency domain simulation using an alternating current (AC) source.

17. The article of manufacture of claim 16 further comprising instructions for running the frequency domain simulation of the SPICE model using the generated set of operating points with a direct current (DC) offset voltage superimposed on the AC source.

18. The article of manufacture of claim 16 further comprising instructions for generating at least one of a plot and a behavioral model using at least the frequency domain simulation of the SPICE model at the selected instance during the period of time.

19. The article of manufacture of claim 17 further comprising instructions for generating at least one of a plot and a behavioral model using at least the frequency domain simulation of the SPICE model at the selected instance during the period of time.

20. The article of manufacture of claim 16 wherein said instructions for generating a set of operating points for the electronic device comprises further instructions for generating a voltage and a corresponding current value for a corresponding set of nodes and branches in the electronic device at the selected instance during the period of time.

21. The article of manufacture of claim 16 wherein said instructions for generating a set of operating points for the electronic device at a selected instance during the period of time comprises further instructions for generating and saving the set of operating points corresponding to the selected instance during the period of time.

22. The article of manufacture of claim 16 said instructions for running a time domain simulation using a waveform as input into the SPICE model of the electronic device comprises further instructions for using a waveform having any one of a high to low transition, a low to high transition, a 3-state to high transition, a 3-state to low transition, a high to 3-state transition, and a low to 3-state transition as input into the SPICE model.

23. A method to characterize an electronic device comprising:
inputting a waveform into a circuit comprising the electronic device, the electronic device having a load across the output of the electronic device;
recording one or more sets of operating points for the circuit comprising the electronic device for a duration of the input waveform;
setting up a circuit using a selected set of operating points from the one or more sets of operating points;
replacing the load with an alternating current (AC) source; and
measuring current through the output for a AC waveform generated by the AC source.

24. The method of claim 23 further comprising measuring the current through the output with a direct current (DC) offset voltage superimposed on the AC source.

25. The method of claim 23 further comprising generating at least one of a plot and a behavioral model using at least the current through the output of the electronic device.

26. The method of claim 24 further comprising generating at least one of a plot and a behavioral model using at least the current through the output of the electronic device.
